(19) United States
(12) Patent Application Publication
(10) Pub. No.: US 2026/0039523 A1
(43) Pub. Date: Feb. 5, 2026

(54) GUARD INTERVAL (GI) AND LONG TRAINING FIELD (LTF) OPTION FOR DISTRIBUTED RESOURCE UNITS (DRUs)

(71) Applicant: MaxLinear, Inc., Carlsbad, CA (US)

(72) Inventors: Avi Avraham Mansour, Givat-Shmuel (IL); Ziv Avital, Kadima (IL); Daniel Keschet, Ein Vered (IL); Rainer Strobel, München (DE); Sigurd Schelstraete, Menlo Park, CA (US); Iñaki Val Beitia, Vitoria (ES); Marcos Martínez Vázquez, Barcelona (ES)

(73) Assignee: MaxLinear, Inc., Carlsbad, CA (US)

(21) Appl. No.: 19/290,281

(22) Filed: Aug. 4, 2025

Related U.S. Application Data
(60) Provisional application No. 63/679,007, filed on Aug. 2, 2024.
(60) Provisional application No. 63/690,798, filed on Sep. 4, 2024.

(51) Int. Cl. H04L 27/26; H04W 84/12

(52) U.S. Cl. CPC H04L 27/2605; H04W 84/12

(57) ABSTRACT

A station (STA) may include a processing device. The processing device may select, at a STA for transmission to an access point (AP), a long training field (LTF) mode in which the LTF mode is 4×LTF. The processing device may select, at the STA for the transmission to the AP, a first guard interval having a value of less than 3.2 μs in which the first guard interval is used for one or more of training symbols or data symbols. The STA may include a transceiver. The transceiver may transmit, from the STA to the AP, the transmission using the LTF mode and the first guard interval. The transceiver may transmit, from the STA to the AP, the transmission using one or more distributed resource units (DRUs).

### RELATED APPLICATION

This application claims the benefit of U.S. Provisional Application No. 63/679,007, filed Aug. 2, 2024, and U.S. Provisional Application No. 63/690,798, filed Sep. 4, 2024 the disclosures of which are each incorporated herein by reference in their entireties for all purposes.

The examples discussed in the present disclosure are related to range extension for the Institute of Electrical and Electronics Engineering (IEEE®) 802.11 standard.

### BACKGROUND

Unless otherwise indicated herein, the materials described herein are not prior art to the claims in the present application and are not admitted to be prior art by inclusion in this section.

IEEE® 802.11 (“802.11”) may be a packet-based protocol. A physical layer protocol data unit (PPDU) may include preamble fields and data fields. The preamble field may include transmission vector format information. The data field may include user payload and higher layer headers (e.g., medium access control (MAC) fields and cyclic redundancy check (CRC)). The transmission vector format and the PPDU structure may vary between 802.11 versions such as 802.11a, 802.11b, 802.11g, 802.11n (Wi-Fi® 4), 802.11ac (Wi-Fi® 5), 802.11ax (Wi-Fi® 6), and so forth.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, a station (STA) may include a processing device. The processing device may select, at a STA for transmission to an access point (AP), a long training field (LTF) mode in which the LTF mode is 4×LTF. The processing device may select, at the STA for the transmission to the AP, a first guard interval having a value of less than 3.2 μs in which the first guard interval is used for one or more of training symbols or data symbols. The STA may include a transceiver. The transceiver may transmit, from the STA to the AP, the transmission using the LTF mode and the first guard interval. The transceiver may transmit, from the STA to the AP, the transmission using one or more distributed resource units (DRUs).

In some examples, an AP may include a transceiver. The transceiver may receive a transmission from a STA, in which the transmission has one or more distributed resource units. The AP may have a processing device. The processing device may identify, at the AP from the transmission, a LTF mode in which the LTF mode is 4×LTF. The processing device may identify, at the AP from the transmission, a first guard interval having a value of less than 3.2 μs in which the first guard interval is used for one or more of training symbols or data symbols.

In some examples, a method may include one or more of: selecting, at a STA for a transmission to an AP, a LTF mode in which the LTF mode is 4×LTF. The method may include selecting, at the STA for the transmission to the AP, a first guard interval having a value of less than 3.2 μs in which the first guard interval is used for one or more of training symbols or data symbols. The method may include transmitting, from the STA to the AP, the transmission using the LTF mode and the first guard interval. The method may include transmitting, from the STA to the AP, the transmission using one or more DRUs.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example ultra high reliability (UHR) physical layer protocol data unit (PPDU).

FIG. 2 illustrates a block diagram of an example system that may provide a guard interval (GI) and long training field (LTF) option for distributed resource units (DRUs).

FIG. 3 illustrates a process flow of a GI and LTF option for DRUs.

FIG. 4 illustrates a process flow of a GI and LTF option for DRUs.

FIG. 5 illustrates a diagrammatic representation of a machine in the example form of a computing device within which a set of instructions, for causing the machine to perform any one or more of the methods discussed herein, may be executed.

FIG. 6 illustrates a graph of the megabits per second (Mbps) as a function of the signal-to-noise ratio (SNR) for regular resource units (RRUs) having a GI of 1.6 μs, DRUs having a GI of 1.6 μs, and DRUs having a GI of 3.2 μs.

FIG. 7 illustrates a graph of the decibels (dB) as a function of the modulation and coding scheme (MCS) for DRUs having a GI of 1.6 μs and DRUs having a GI of 3.2 μs.

### DESCRIPTION

Uplink orthogonal frequency-division multiple access (UL-OFDMA) may allow access points to receive data from multiple stations. When using UL-OFDMA, distributed-resource units (DRUs) may be a feature for range extension for the Institute of Electrical and Electronics Engineers (IEEE®) 802.11bn standard (i.e., Wi-Fi® 8).

For specific long training field (LTF) modes (e.g., 1×LTF or 2×LTF), the overhead of the LTF duration time may be reduced. For example, 1×LTF mode may reduce the LTF duration time by a quarter because this mode may transmit 1 out of 4 tones from the full set of LTF tones. In addition, 2×LTF mode may reduce the LTF duration time by a half because this mode may transmit 1 out of 2 tones from the full set of LTF tones. The full set of LTF tones may be transmitted using 4×LTF mode. When using 1×LTF mode (e.g., transmitting one-quarter of the full set of LTF tones) or using 2×LTF mode (e.g., transmitting half of the full set of LTF tones), the partial tones may be selected at even indices. To obtain the missing tones (e.g., the tones having odds indices), the receiver may use interpolation.

When using a DRU tone-plan, the tone location recommendations may result in DRU cases that use odd bins. Using odd bins may prevent the use of LTF modes that use partial tones such as 1×LTF or 2×LTF because the receiver may not interpolate the LTF tones without the even tones. In this scenario in which 1×LTF or 2×LTF may not be used, one remaining option is to transmit the full set of LTF tones by using 4×LTF. Therefore, when using a DRU tone-plan, 4×LTF with a guard interval (GI) of 3.2 μs may be used. Regular RUs may support 1×LTF and 2×LTF (which may allow for GIs of 0.8, 1.6, and/or 3.2 μs). However, for a DRU tone-plan 1×LTF and 2×LTF may not be available because interpolation may not be performed without the even tones.

For the high-efficiency and extremely high throughput (HE/EHT) guard interval and LTF modes, one option is to use 4×LTF with a 3.2 μs GI (i.e., 4×HE/EHT-LTF+3.2 μs GI). Using 4×HE/EHT-LTF+3.2 μs GI may transmit the full set of LTF tones but may also cause high overhead and lower throughput. The high overhead and lower throughput may result from the relatively longer GI of 3.2 μs when compared to the GI of 1.6 μs when using 1×LTF (e.g., 1×HE/EHT-LTF+1.6 μs GI) or 2×LTF (e.g., 2×HE/EHT-LTF+1.6 μs GI).

As shown in Table 1, particular subfield values may be associated with different LTF modes and GIs. For example, a GI and HE/EHT-LTF type subfield value of 0 may be associated with 1×HE/EHT-LTF+1.6 μs GI. In addition, a GI and HE/EHT-LTF type subfield value of 1 may be associated with 2×HE/EHT-LTF+1.6 μs GI. In addition, a GI and HE/EHT-LTF type subfield value of 2 may be associated with 4×HE/EHT-LTF+3.2 μs GI. A GI and HE/EHT-LTF type subfield value of 3 may not be associated with an LTF mode or a GI.

TABLE 1
GI + LTF HE/EHT for trigger based OFDMA

| GI and HE/EHT-LTF | |
|---|---|
| Type subfield value | Description |
| 0 | 1 x HE/EHT-LTF + 1.6 μs GI |
| 1 | 2 x HE/EHT-LTF + 1.6 μs GI |
| 2 | 4 x HE/EHT-LTF + 3.2 μs GI |
| 3 | Reserved |

Therefore, when transmitting the full set of tones, 4×HE/EHT-LTF+3.2 μs GI may be used, but at the cost of higher overhead and lower throughput. Therefore, methods of transmitting the full set of tones without the higher overhead and/or lower throughput may be useful.

In one example, a combination including a shorter guard interval for 4×LTF mode may be used to reduce the overhead and increase the throughput when transmitting the full set of tones. When using UL OFDMA for DRU traffic, a guard interval of less than 3.2 μs may be used. This shorter guard interval may be e.g., 1.6 μs and/or 0.8 μs. By reducing the guard interval in this way while also transmitting the full set of tones, the odd-indexed tones may be determined.

The difference in overhead depends on the length of the guard interval in comparison to 3.2 μs. For example, for a reduced guard interval of 1.6 μs, the reduced amount of overhead may be 1.6 μs compared to a 3.2 μs guard interval. For a 16 μs symbol length, a reduction of 1.6 μs for a data symbol would facilitate a performance increase of 10% in the data throughput (not including the preamble overhead, e.g., for long packets). For a reduced guard interval of 0.8 μs, the reduced amount of overhead may be 2.4 μs compared to a 3.2 μs guard interval. For a 16 μs symbol length, a reduction of 2.4 μs for a data symbol would facilitate a performance increase of 15% in the data throughput (not including the preamble overhead, e.g., for long packets).

Examples of the present disclosure will be explained with reference to the accompanying drawings.

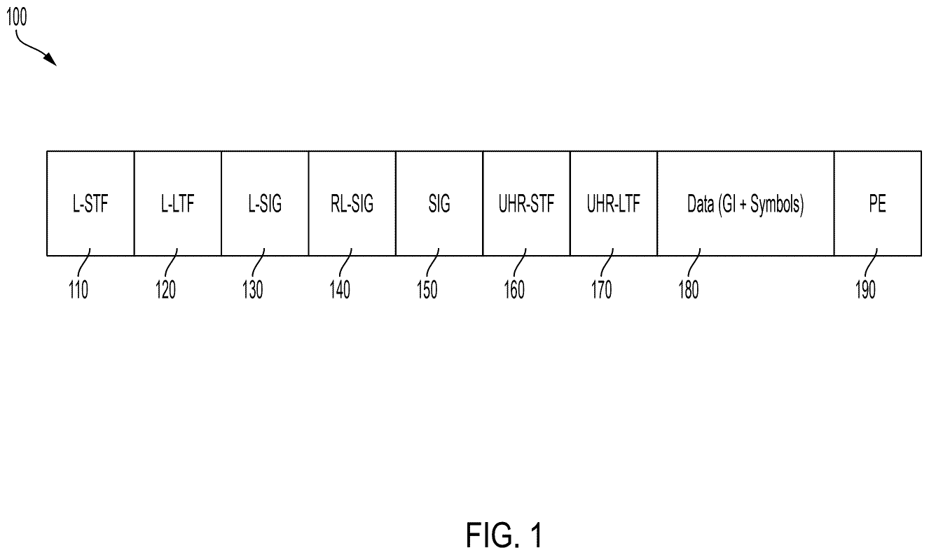

FIG. 1 illustrates an example of an ultra high reliability (UHR) physical layer protocol data unit (PPDU) 100. The UHR PPDU 100 may include one or more of a legacy short training field (L-STF) 110, a legacy long training field (L-LTF) 120, a legacy signal field (L-SIG) 130, a repeated legacy signal field (RL-SIG) 140, a signal field 150, a UHR short training field (UHR-STF) 160, a UHR long training field (UHR-LTF) 170, data field 180 including a GI and symbols, or a packet extension (PE) 190.

In one example, a station (STA) may include a processing device. The processing device may select, at STA for transmission to an access point (AP), a long training field (LTF) mode. The LTF mode may be 4×LTF. The processing device may select, at the STA for the transmission to the AP, a first guard interval having a value of less than 3.2 μs. The first guard interval may be used for one or more of training symbols (e.g., UHR-LTF) or data symbols. The station may include a transceiver. The transceiver may transmit, from the STA to the AP, the transmission using the LTF mode and the first guard interval. The transceiver may transmit the transmission using one or more DRUs. In addition or alternatively, the transceiver may transmit the transmission using trigger-based OFDMA.

The first guard interval may be any suitable value of less than 3.2 μs and greater than 0. In one example, the first guard interval may have a value of less than one or more of: 3.2 μs, 3.1 μs, 3.0 μs, 2.9 μs, 2.8 μs, 2.7 μs, 2.6 μs, 2.5 μs, 2.4 μs, 2.3 μs, 2.2 μs, 2.1 μs, 2.0 μs, 1.9 μs, 1.8 μs, 1.7 μs, 1.6 μs, 1.5 μs, 1.4 μs, 1.3 μs, 1.2 μs, 1.1 μs, 1.0 μs, 0.9 μs, 0.8 μs, 0.7 μs, 0.6 μs, 0.5 μs, 0.4 μs, 0.3 μs, 0.2 μs, 0.1 μs, the like, or a combination thereof. The first guard interval may have a value of about 1.6 μs, about 0.8 μs, 0.4 μs, or the like.

Unlike a 1×LTF mode (in which one-quarter of the full set of tones may be transmitted) and a 2×LTF mode (in which one-half of the full set of tones may be transmitted), the LTF mode may be a 4×LTF mode in which the full set of tones may be transmitted. The 4×LTF mode may be a 4×UHR-LTF mode. The 4×UHR-LTF mode may be used with trigger-based PPDU (TB-PPDU) for DRUs.

The station may have a first guard interval used for training symbols and a second guard interval used for data symbols. The second guard interval may have a value of less than 3.2 μs. Alternatively or in addition, the first guard interval may be used for data symbols and the second guard interval may be used for training symbols. The second guard interval may have any suitable value as provided with respect to the first guard interval. The first guard interval and the second guard interval may have different values.

The transmission from the STA may be transmitted to an AP. An AP may include a transceiver to receive a transmission from the STA and a processing device. The processing device may identify, at the AP from the transmission, an LTF mode. The LTF mode may be a 4×LTF mode in which the full set of tones is received. The processing device may identify, at the AP from the transmission, a first guard interval having a value of less than 3.2 μs. The first guard interval may be used for one or more of training symbols or data symbols and may have the values as described in reference to the STA. The transceiver may receive the transmission having one or more DRUs. The transceiver may receive the transmission in 4×LTF mode, which may be a 4×UHR-LTF mode.

The transceiver, at the AP, may also receive the transmission in which a second guard interval has a value of less than 3.2 μs. The first guard interval may be used for training symbols and the second guard interval may be used for data symbols. Alternatively or in addition, the first guard interval may be used for data symbols and the second guard interval may be used for training symbols.

In one example, as provided in Table 2A, the GI and HE/EHT-LTF type subfield value of 3 may be associated with a combination of a 4×LTF mode (e.g., 4×HE/EHT-LTF) and a shorter guard interval (e.g., less than 3.2 μs such as 1.6 μs, 0.8 μs, or the like).

TABLE 2A
GI and HE/EHT-LTF Type subfield value

| GI and HE/EHT-LTF | |
|---|---|
| Type subfield value | Description |
| 0 | 1 x HE/EHT-LTF + 1.6 μs GI |
| 1 | 2 x HE/EHT-LTF + 1.6 μs GI |
| 2 | 4 x HE/EHT-LTF + 3.2 μs GI |
| 3 | 4 x HE/EHT-LTF + 1.6 μs GI |

In one example, as provided in Table 2B, the GI and UHR-LTF type subfield value of 3 may be associated with a combination of a 4×LTF mode (e.g., 4×UHR-LTF) and a shorter guard interval (e.g., less than 3.2 μs such as 1.6 μs, 0.8 μs, or the like).

TABLE 2B
GI and HE/EHT-LTF Type subfield value

| GI and UHR-LTF Type | |
|---|---|
| subfield value | Description |
| 0 | 1 x UHR-LTF + 1.6 μs GI |
| 1 | 2 x UHR-LTF + 1.6 μs GI |
| 2 | 4 x UHR-LTF + 3.2 μs GI |
| 3 | 4 x UHR-LTF + 1.6 μs GI |

Table 3A provides data and pilot subcarrier indices for DRUs in a 20 megahertz (MHz) UHR PPDU.

TABLE 3A
Data and Pilot Subcarrier Indices for DRUs in a 20 MHz UHR PPDU
Data and pilot subcarrier indices for DRUs in a 20 MHz UHR PPDU

| DRU | | | | | |
|---|---|---|---|---|---|
| Type | DRU index and subcarrier range | | | | |
| 26-tone | DRU1 | DRU2 | DRU3 | DRU4 | DRU5 |
| DRU | [−120:9:−12, | [−116:9:−8, | [−118:9:−10, | [−114:9:−6, | [−112:9:−4, |
| i = 1:9 | 6:9:114] | 10:9:118] | 8:9:116] | 12:9:120] | 5:9:113] |
| | DRU6 | DRU7 | DRU8 | DRU9 | |
| | [−119:9:−11, | [−115:9:−7, | [−117:9:−9, | [−113:9:−5, | |
| | 7:9:115] | 11:9:119] | 9:9:117] | 4:9:112] | |
| 52-tone | DRU1 | | DRU2 | | |
| DRU | 26-tone [DRU1, DRU2] | | 26-tone [DRU3, DRU4] | | |
| i = 1:4 | DRU3 | | DRU4 | | |
| | 26-tone [DRU6, DRU7] | | 26-tone [DRU8, DRU9] | | |
| 106-tone | DRU1 | | DRU2 | | |
| DRU | 26-tone [DRU1~4], [−3, 3] | | 26-tone [DRU6~9], [−2, 2] | | |
| i = 1:2 | | | | | |

Table 3B provides data and pilot subcarrier indices for DRUs in a 40 MHZ UHR PPDU.

TABLE 3B
Data and Pilot Subcarrier Indices for DRUs in a 40 MHz UHR Trigger Based (TB) PPDU
Data and pilot subcarrier indices for DRUs in a 40 MHz UHR TB PPDU

| DRU | | | | | | |
|---|---|---|---|---|---|---|
| Type | DRU index and subcarrier range | | | | | |
| 26- | DRU1 | DRU2[−233:18:−17, | DRU3 [−238:18:−22, | DRU4[−229:18:−13, | DRU5[−225:18:−9, | DRU6[−240:18:−24, |
| tone | [−242:18:−26, | 19:18:235] | 14:18:230] | 23:18:239] | 27:18:243] | 12:18:228] |
| DRU | 10:18:226] | | | | | |
| i = | DRU7[−231:18:−15, | DRU8[−236:18:−20, | DRU9[−227:18:−11, | DRU10 [−241:18:−25, | DRU11 [−232:18:−16, | DRU12 [−237:18:−21 |
| 1:18 | 21:18:237] | 16:18:232] | 25:18:241] | 11:18:227] | 20:18:236] | 15:18:231] |
| | DRU13[−228:18:−12, | DRU14 [−234:18:−18, | DRU15[−239:18:−23, | DRU16 [−230:18:−14, | DRU17 [−235:18:−19, | DRU18 [−226:18:−10, |
| | 24:18:240] | 18:18:234] | 13:18:229] | 22:18:238] | 17:18:233] | 26:18:242] |
| 52- | DRU1 [−242:9:−17, 10:9:235] | | DRU2 [−238:9:−13, 14:9:239] | | DRU3 [−240:9:−15, 12:9:237] | |
| tone | DRU4 [−236:9:−14, | | DRU5 [−241:9:−16, | | DRU6 [−237:9:−12, | |
| DRU | 13:9:238] | | 11:9:236] | | 15:9:240] | |
| i = | DRU7 [−239:9:−14, | | DRU8 [−235:9:−10, | | | |
| 1:8 | 13:9:238] | | 17:9:242] | | | |
| 106- | DRU1 26-tone [DRU1~4], | | DRU2 26-tone [DRU6~9], | | DRU3 26-tone [DRU10~13], | |
| tone | [−8, 5] | | [−6, 7] | | [−7, 6] | |
| DRU | | | | | | |
| i = | | | | | | |
| 1:4 | | | | | | |
| | DRU4 26- | | | | | |
| | tone | | | | | |
| | [DRU15~18], | | | | | |
| | [−5, 8] | | | | | |
| 242- | DRU1 106-tone [DRU1~2], | | DRU2 106-tone | | | |
| tone | 26-tone DRU5, [−244, −4, 3, 9] | | [DRU3~4], 26-tone | | | |
| DRU | | | DRU14, [−243, −3, 4, 244] | | | |
| i = | | | | | | |
| 1:2 | | | | | | |

Table 3C provides data and pilot subcarrier indices for DRUs in an 80 MHZ UHR PPDU.

TABLE 3C
Data and Pilot Subcarrier Indices for DRUs in a 80 MHz UHR TB PPDU
Data and pilot subcarrier indices for DRUs in a 80 MHz UHR TB PPDU

| DRU | | | | |
|---|---|---|---|---|
| Type | DRU index and subcarrier range | | | |
| 52- | DRU1 | DRU2 | DRU3 | DRU4 |
| tone | [−483:36:−51, | [−475:36:−43, | [−479:36:−47, | [−471:36:−39, |
| DRU | 17:36:449], | 25:36:457], | 21:36:453], | 29:36:461], |
| i = 1:16 | [−467:36:−35, | [−459:36:−27, | [−463:36:−31, | [−455:36:−23, |
| | 33:36:465] | 41:36:473] | 37:36:469] | 45:36:477] |
| | DRU5 | DRU6 | DRU7 | DRU8 |
| | [−477:36:−45, | [−469:36:−37, | [−481:36:−49, | [−473:36:−41, |
| | 23:36:455], | 31:36:463], | 19:36:451], | 27:36:459], |
| | [−461:36:−29, | [−453:36:−21, | [−465:36:−33, | [−457:36:−25, |
| | 39:36:471] | 47:36:479] | 35:36:467] | 43:36:475] |
| | DRU9 | DRU10 | DRU11 | DRU12 |
| | [−482:36:−50, | [−474:36:−42, | [−478:36:−46, | [−470:36:−38, |
| | 18:36:450], | 26:36:458], | 22:36:454], | 30:36:462], |
| | [−466:36:−34, | [−458:36:−26, | [−462:36:−30, | [−454:36:−22, |
| | 34:36:466] | 42:36:474] | 38:36:470] | 46:36:478] |
| | DRU13 | DRU14 | DRU15 | DRU16 |
| | [−476:36:−44, | [−468:36:−36, | [−480:36:−48, | [−472:36:−40, |
| | 24:36:456], | 32:36:464], | 20:36:452], | 28:36:460], |
| | [−460:36:−28, | [−452:36:−20, | [−464:36:−32, | [−456:36:−24, |
| | 40:36:472] | 48:36:480] | 36:36:468] | 44:36:476] |
| 106- | DRU1 | DRU2 | DRU3 | DRU4 |
| tone | 52- | 52-tone | 52- | 52- |
| DRU | tone[DRU1~2], | [DRU3~4], | tone[DRU5~6], | tone[DRU7~8], |
| i = 1:8 | [−495,485] | [−491,489] | [−489,491] | [−493,487] |
| | DRU5 | DRU6 | DRU7 | DRU8 |
| | 52- | 52- | 52-tone | 52- |
| | tone[DRU9~10, | tone[DRU11~12], | [DRU13~14], | tone[DRU15~16], |
| | [−494,486] | [−490,490] | [−488,492] | [−492,488] |
| 242- | DRU1 | | DRU2 | |
| tone | [−499:4:−19, 17:4:497] | | [−497:4:−17, 19:4:499] | |
| DRU | DRU3 | | DRU4 | |
| i = 1:4 | [−498:4:−18, 18:4:498] | | [−496:4:−16, 20:4:500] | |
| 484- | DRU1 | | DRU2 | |
| tone | [−499:2:−17, 17:2:499] | | [−498:2:−16, 18:2:500] | |
| DRU | | | | |
| i = 1:2 | | | | |

Modifications, additions, or omissions may be made to the components of FIG. 1 without departing from the scope of the present disclosure.

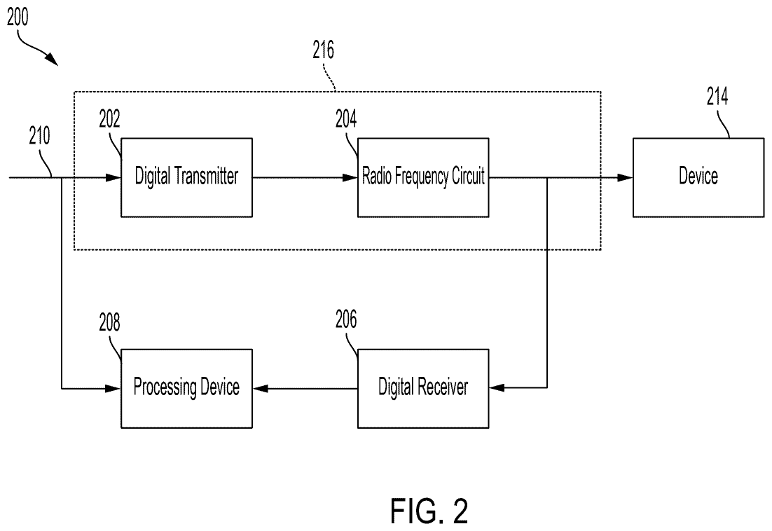

FIG. 2 illustrates a block diagram of an example communication system 200 that may provide a GI and LTF option for DRUs, in accordance with at least one example described in the present disclosure. The communication system 200 may include a digital transmitter 202, a radio frequency circuit 204, a device 214, a digital receiver 206, and a processing device 208. The digital receiver 206 and the processing device 208 may receive a baseband signal via connection 210. A transceiver 216 may include the digital transmitter 202 and the radio frequency circuit 204.

In some examples, the communication system 200 may include a system of devices that may be configured to communicate with one another via a wired or wireline connection. For example, a wired connection in the communication system 200 may include one or more Ethernet cables, one or more fiber-optic cables, and/or other similar wired communication mediums. Alternatively, or additionally, the communication system 200 may include a system of devices that may communicate via one or more wireless connections. For example, the communication system 200 may include one or more devices that may transmit and/or receive radio waves, microwaves, ultrasonic waves, optical waves, electromagnetic induction, and/or similar wireless communications. Alternatively, or additionally, the communication system 200 may include combinations of wireless and/or wired connections. In these and other examples, the communication system 200 may include one or more devices that may obtain a baseband signal, perform one or more operations to the baseband signal to generate a modified baseband signal, and transmit the modified baseband signal, such as to one or more loads.

In some examples, the communication system 200 may include one or more communication channels that may communicatively couple systems and/or devices included in the communication system 200. For example, the transceiver 216 may be communicatively coupled to the device 214.

In some examples, the transceiver 216 may obtain a baseband signal. For example, as described herein, the transceiver 216 may generate a baseband signal and/or receive a baseband signal from another device. In some examples, the transceiver 216 may transmit the baseband signal. For example, upon obtaining the baseband signal, the transceiver 216 may transmit the baseband signal to a separate device, such as the device 214. Alternatively, or additionally, the transceiver 216 may modify, condition, and/or transform the baseband signal in advance of transmitting the baseband signal. For example, the transceiver 216 may include a quadrature up-converter and/or a digital to analog converter (DAC) that may modify the baseband signal. Alternatively, or additionally, the transceiver 216 may include a direct radio frequency (RF) sampling converter that may modify the baseband signal.

In some examples, the digital transmitter 202 may obtain a baseband signal via connection 210. In some examples, the digital transmitter 202 may up-convert the baseband signal. For example, the digital transmitter 202 may include a quadrature up-converter to apply to the baseband signal. In some examples, the digital transmitter 202 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 202.

In some examples, the transceiver 216 may include one or more subcomponents that may be used in preparing the baseband signal and/or transmitting the baseband signal. For example, the transceiver 216 may include an RF front end (e.g., in a wireless environment) which may include a power amplifier (PA), a digital transmitter (e.g., 202), a digital front end, an IEEE® 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 204) of the transceiver 216 may be synchronized with the resource controller via the S-plane device, which may contribute to high-accuracy timing with respect to a reference clock.

In some examples, the transceiver 216 may obtain the baseband signal for transmission. For example, the transceiver 216 may receive the baseband signal from a separate device, such as a signal generator. For example, the baseband signal may come from a transducer that may convert a variable into an electrical signal, such as an audio signal output of a microphone picking up a speaker's voice. Alternatively, or additionally, the transceiver 216 may generate a baseband signal for transmission. In these and other examples, the transceiver 216 may transmit the baseband signal to another device, such as the device 214.

In some examples, the device 214 may receive a transmission from the transceiver 216. For example, the transceiver 216 may transmit a baseband signal to the device 214.

In some examples, the radio frequency circuit 204 may transmit the digital signal received from the digital transmitter 202. In some examples, the radio frequency circuit 204 may transmit the digital signal to the device 214 and/or the digital receiver 206. In some examples, the digital receiver 206 may receive a digital signal from the RF circuit and/or send a digital signal to the processing device 208.

In some examples, the processing device 208 may be a standalone device or system, as illustrated. Alternatively, or additionally, the processing device 208 may be a component of another device and/or system. For example, in some examples, the processing device 208 may be included in the transceiver 216. In instances in which the processing device 208 is a standalone device or system, the processing device 208 may communicate with additional devices and/or systems remote from the processing device 208, such as the transceiver 216 and/or the device 214. For example, the processing device 208 may send and/or receive transmissions from the transceiver 216 and/or the device 214. In some examples, the processing device 208 may be combined with other elements of the communication system 200.

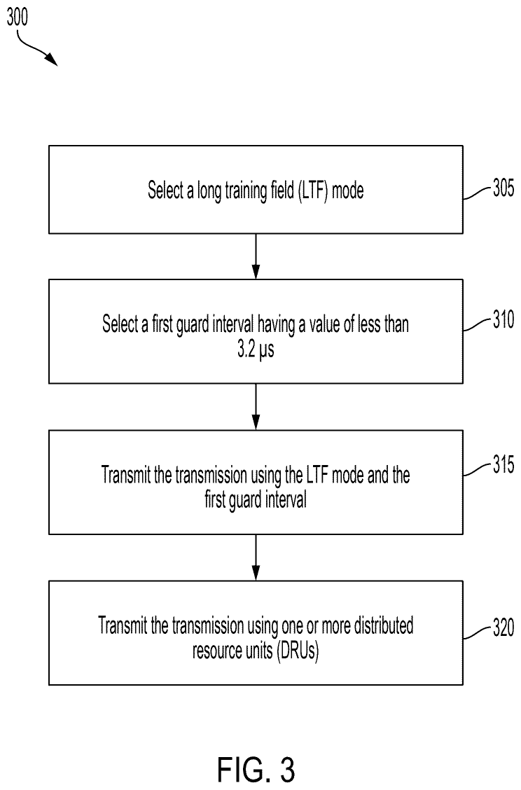

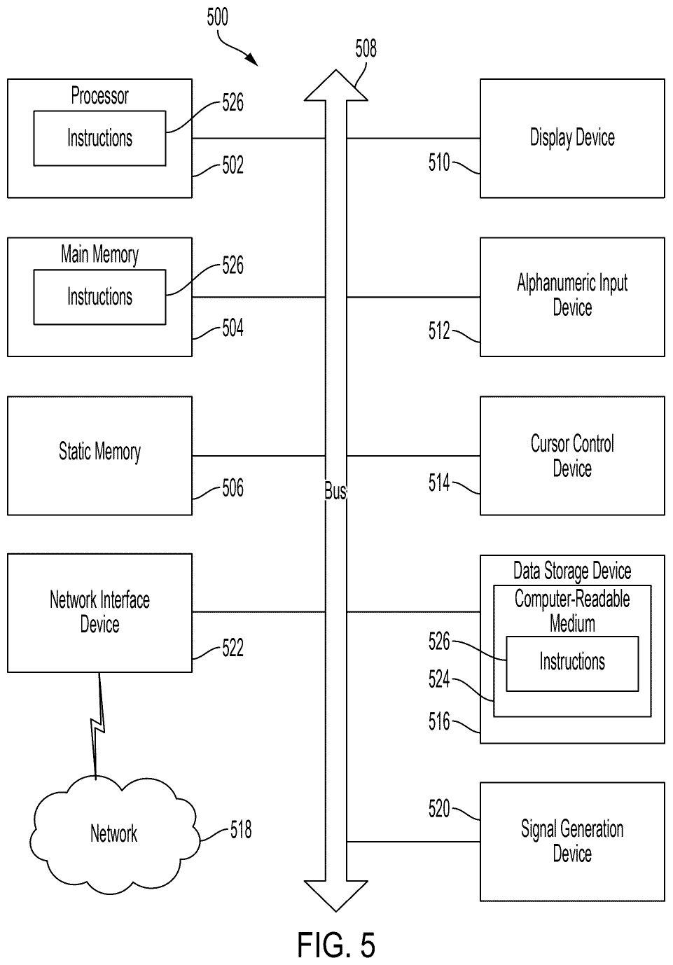

FIG. 3 illustrates a process flow of an example method 300 of a GI and LTF option for DRUs, in accordance with at least one example described in the present disclosure. The method 300 may be arranged in accordance with at least one example described in the present disclosure. The method 300 may be performed by processing logic that may include hardware (circuitry, dedicated logic, etc.), software (such as is run on a computer system or a dedicated machine), or a combination of both, which processing logic may be included in the processing device 502 of FIG. 5, the communication system 200 of FIG. 2, or another device, combination of devices, or systems.

The method 300 may begin at block 305 where the processing logic may select, at a STA for a transmission to an AP, an LTF mode in which the LTF mode may be 4×LTF.

As shown in block 310, the processing logic may select, at the STA for transmission to the AP, a first guard interval having a value of less than 3.2 μs in which the first guard interval may be used for one or more of training symbols or data symbols.

As shown in block 315, the processing logic may transmit, from the STA to the AP, the transmission using the LTF mode and the first guard interval.

As shown in block 320, the processing logic may transmit, from the STA to the AP, the transmission using one or more DRUs.

Modifications, additions, or omissions may be made to the method 300 without departing from the scope of the present disclosure. For example, in some examples, the method 300 may include any number of other components that may not be explicitly illustrated or described.

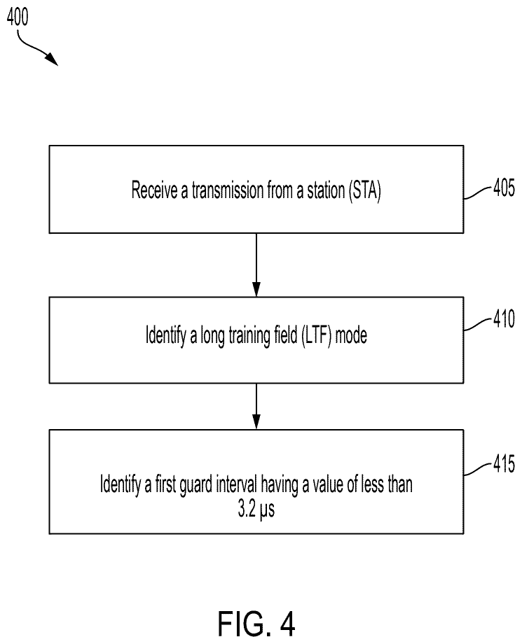

FIG. 4 illustrates a process flow of an example method 400 of a GI and LTF option for DRUs, in accordance with at least one example described in the present disclosure. The method 400 may be arranged in accordance with at least one example described in the present disclosure.

The method 400 may be performed by processing logic that may include hardware (circuitry, dedicated logic, etc.), software (such as is run on a computer system or a dedicated machine), or a combination of both, which processing logic may be included in the processing device 502 of FIG. 5, the communication system 200 of FIG. 2, or another device, combination of devices, or systems.

The method 400 may begin at block 405 where the processing logic may receive a transmission from a station (STA).

As shown in block 410, the processing logic may identify, at the AP from the transmission, an LTF mode in which the LTF mode may be 4×LTF.

As shown in block 415, the processing logic may identify, at the AP from the transmission, a first guard interval having a value of less than 3.2 μs in which the first guard interval may be used for one or more of training symbols or data symbols.

Modifications, additions, or omissions may be made to the method 400 without departing from the scope of the present disclosure. For example, in some examples, the method 400 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 5 illustrates a diagrammatic representation of a machine in the example form of a computing device 500 within which a set of instructions, for causing the machine to perform any one or more of the methods discussed herein, may be executed. The computing device 500 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 500 includes a processing device 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

Processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one example, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over a network 518 via the network interface device 522.

While the computer-readable storage medium 524 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

### EXAMPLES

The following provide examples of the performance characteristics according to the present disclosure.

### Example 1: DRU Power Gains

As provided in Table 4, the possible power gain of using DRUs may be tied to the number of users in the UL OFDMA transmission. Table 4 shows: (1) the number of resource units (N_{RU}) which may be 26, 52, 106, 242, 484, or 996, (2) the spreading bandwidth which may be 20 MHz, 40 MHz, 80 MHz, or 160 MHz, and (3) the power gain in decibels. The two-user case includes the bolded numbers (i.e., 3.29 dB, 2.62 dB, 2.62 dB, and 2.62 dB). The four-user case includes the italicized numbers (i.e., 6.30 dB, 6.30 dB, 5.05 dB, and 5.05 dB).

TABLE 4
Power gain for 2 users and 4 users

Spreading Bandwidth

| N_{RU} | 20 | 40 | | 80 | | 160 | |
|---|---|---|---|---|---|---|---|
| 26 | 8.06 dB | 11.07 | dB | 11.07 | dB | 11.07 | dB |
| 52 | 6.30 dB | 8.06 | dB | 11.07 | dB | 11.07 | dB |
| 106 | 3.29 dB | 6.30 | dB | 8.06 | dB | 11.07 | dB |
| 242 | N/A | 2.62 | dB | 5.05 | dB | 8.06 | dB |

| | | | | | | |
|---|---|---|---|---|---|---|
| 484 | N/A | N/A | 2.62 | dB | 5.05 | dB |

| | | | | | |
|---|---|---|---|---|---|
| 996 | N/A | N/A | N/A | 2.62 | dB |

### Example 2: Impact of GI Values in Two-User Case

The two-user case may be used to analyze UL OFDMA. OFDMA may operate in situations in which STAs have simultaneous traffic. However, with larger OFDMA groups, STAs may not have simultaneous traffic. In addition, due to uplink target receive power constraints, combining STAs at different distances from the AP may degrade the performance of the STAs that may be closer to the AP. Thus, to analyze UL OFDMA, STAs may be selected that may have a similar distance to the AP. To meet these conditions, two-STA groups may be analyzed.

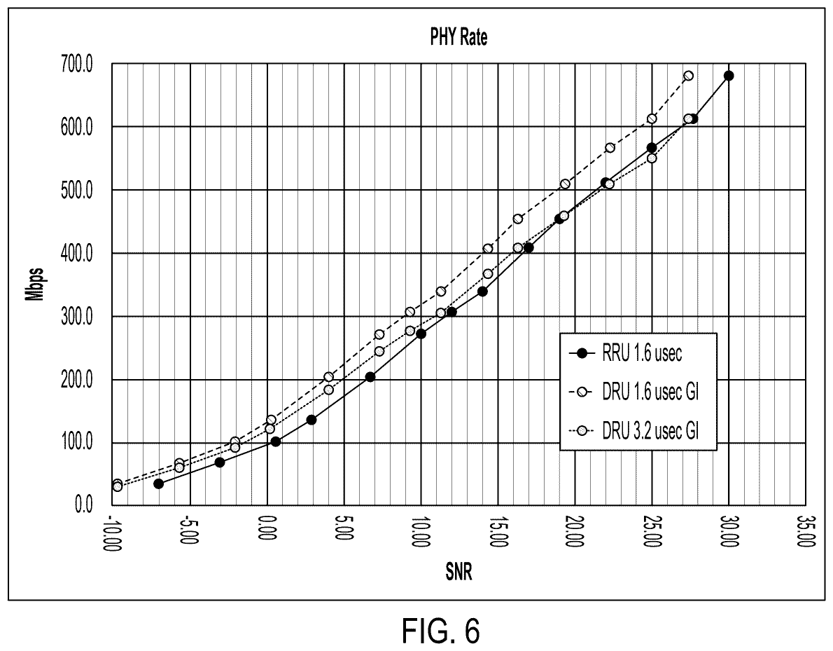

The impact of GI values in the two-user case was determined. As illustrated in FIG. 6, three cases were examined including: (1) performance of RRU with GI=1.6 μs, (2) performance of DRU (2.62 dB gain over RRU) with GI=3.2 μs, and (3) performance of DRU (2.62 dB gain over RRU) with GI=1.6 μs.

The performance (i.e., the physical layer (PHY) rate as measured in Mbps) was impacted by the absence of GI=3.2 μs. A 2.62 dB gain resulted for DRUs that supported GI=1.6 μs. For DRUs with GI=3.2 μs, the performance was worse than for RRUs for mid to high MCS.

### Example 3: SNR Gain as Function of MCS

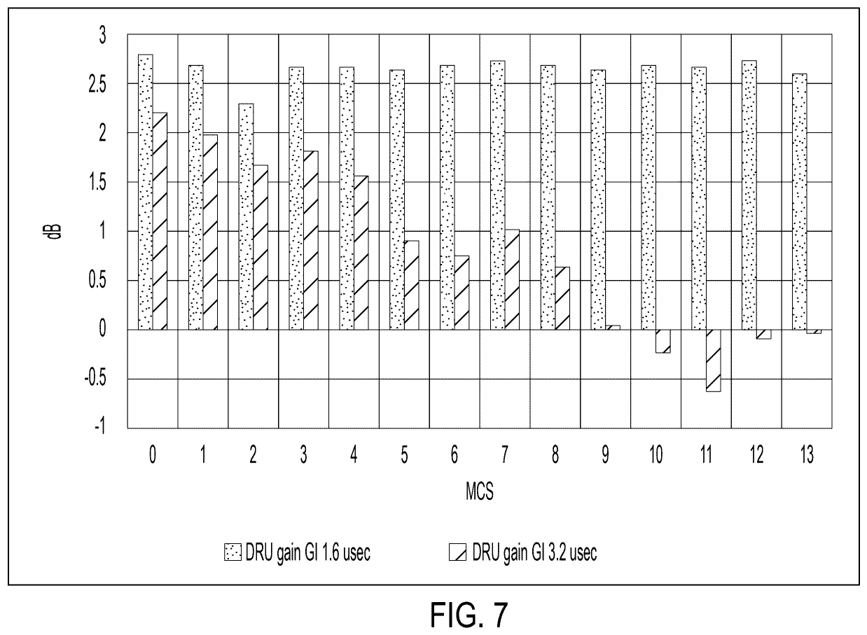

As illustrated in FIG. 7, the SNR gain as a function of MCS was determined. SNR gains were computed relative to RRU with GI=1.6 μs. The expected gain of 2.62 dB disappeared as the MCS increased. The performance of DRUs was worse than RRU for higher MCSs.

Therefore, the absence of support for GI=1.6 μs in DRUs degraded the performance for DRUs in the two-user case. Adding GI=1.6 μs as an option for DRUs may mitigate the performance losses.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A station (STA), comprising:
a processing device operable to:
select, at the STA for transmission to an access point (AP), a long training field (LTF) mode, wherein the LTF mode is 4×LTF; and
select, at the STA for the transmission to the AP, a first guard interval having a value of less than 3.2 μs, wherein the first guard interval is used for one or more of training symbols or data symbols; and
a transceiver operable to:
transmit, from the STA to the AP, the transmission using the LTF mode and the first guard interval; and
transmit, from the STA to the AP, the transmission using one or more distributed resource units (DRUs).

2. The STA of claim 1, wherein the first guard interval has a value of 1.6 μs.

3. The STA of claim 1, wherein the first guard interval has a value of 0.8 μs.

4. The STA of claim 1, wherein the 4×LTF mode is a 4× Ultra High Reliability (UHR)-LTF mode.

5. The STA of claim 1, wherein the transceiver is further operable to transmit the transmission using trigger-based orthogonal frequency-division multiple access (OFDMA).

6. The STA of claim 1, wherein a second guard interval has a value of less than 3.2 μs and wherein:
the first guard interval is used for training symbols and the second guard interval is used for data symbols, or
the first guard interval is used for data symbols and the second guard interval is used for training symbols.

7. The STA of claim 1, wherein the STA is operable to facilitate a signal-to-noise ratio (SNR) gain of 2 decibels (dB) or greater when compared to a second STA using regular resource units (RRUs) with a GI of 1.6 μs.

8. A method, comprising
selecting, at a station (STA) for a transmission to an access point (AP), a long training field (LTF) mode, wherein the LTF mode is 4×LTF;
selecting, at the STA for the transmission to the AP, a first guard interval having a value of less than 3.2 μs, wherein the first guard interval is used for one or more of training symbols or data symbols;
transmitting, from the STA to the AP, the transmission using the LTF mode and the first guard interval; and
transmitting, from the STA to the AP, the transmission using one or more distributed resource units (DRUs).

9. The method of claim 8, wherein the first guard interval has a value of 1.6 μs.

10. The method of claim 8, wherein the first guard interval has a value of 0.8 μs.

11. The method of claim 8, wherein the 4×LTF mode is a 4× Ultra High Reliability (UHR)-LTF mode.

12. The method of claim 8, further comprising transmitting the transmission using trigger-based orthogonal frequency-division multiple access (OFDMA).

13. The method of claim 8, wherein a second guard interval has a value of less than 3.2 μs and wherein:
the first guard interval is used for training symbols and the second guard interval is used for data symbols, or
the first guard interval is used for data symbols and the second guard interval is used for training symbols.

14. The method of claim 8, wherein the STA is operable to facilitate a signal-to-noise ratio (SNR) gain of 2 decibels (dB) or greater when compared to a second STA using regular resource units (RRUs) with a GI of 1.6 μs.

15. An access point (AP), comprising:
a transceiver operable to receive a transmission from a station (STA),
wherein the transmission has one or more distributed resource units, and
a processing device operable to:
identify, at the AP from the transmission, a long training field (LTF) mode, wherein the LTF mode is 4×LTF; and
identify, at the AP from the transmission, a first guard interval having a value of less than 3.2 μs, wherein the first guard interval is used for one or more of training symbols or data symbols.

16. The AP of claim 15, wherein the first guard interval has a value of 1.6 μs.

17. The AP of claim 15, wherein the first guard interval has a value of 0.8 μs.

18. The AP of claim 15, wherein the 4×LTF mode is a 4× Ultra High Reliability (UHR)-LTF mode.

19. The AP of claim 15, further comprising receiving the transmission using trigger-based orthogonal frequency-division multiple access (OFDMA).

20. The AP of claim 15, wherein a second guard interval has a value of less than 3.2 μs and wherein:
the first guard interval is used for training symbols and the second guard interval is used for data symbols, or
the first guard interval is used for data symbols and the second guard interval is used for training symbols.
